(19) United States
(12) Patent Application Publication
(10) Pub. No.: US 2024/0244199 A1
(43) Pub. Date: Jul. 18, 2024

(54) ENCODING/DECODING METHOD FOR PURPOSE OF SCALABLE STRUCTURE-BASED HYBRID TASK

(71) Applicant: KWANGWOON UNIVERSITY INDUSTRY-ACADEMIC COLLABORATION FOUNDATION, Seoul (KR)

(72) Inventors: Dong Gyu SIM, Seoul (KR); Han Sol CHOI, Gyeonggi-do (KR)

(21) Appl. No.: 18/559,339

(22) PCT Filed: Dec. 28, 2022
(86) PCT No.: PCT/KR2022/021457

§ 371 Date: Nov. 6, 2023

(30) Foreign Application Priority Data
Feb. 25, 2022 (KR) 10-2022-0025327
Aug. 30, 2022 (KR) 10-2022-0108917

(51) Int. Cl. H04N 19/117; H04N 19/169; H04N 19/46; H04N 19/80

(52) U.S. Cl. CPC H04N 19/117; H04N 19/1883; H04N 19/46; H04N 19/80

(57) ABSTRACT

The present invention proposes a scalable-based video compression structure in a video compression technology for supporting a hybrid task. In an adaptive loop filter step of an encoder of a layer for a machine task, a coding tree unit may be classified into a coding tree unit significant group and a coding tree unit insignificant group, and, for the coding tree unit significant group, filter coefficients may be derived by a feature domain minimum error method and a task error minimum error method.

### TECHNICAL FIELD

The present disclosure relates to an adaptive loop filter in a video compression technology for a hybrid task, and proposes a method of deriving an adaptive loop filter coefficient by using a feature domain minimum error method and a task error minimum error method.

### BACKGROUND ART

As the industrial field to which a deep neural network using deep learning is applied has expanded, a deep neural network has increasingly applied to industrial machines. For use in application utilizing machine-to-machine communication, a compression method which takes into account not only human visual characteristics but also characteristics which are significant in a deep neural network within machines are being actively researched. A structure of efficiently compressing a video for both a machine vision and a human vision is being studied.

### DISCLOSURE

### Technical Problem

A video compression structure for both a machine vision and a human vision is proposed.

### Technical Solution

The present disclosure proposes a scalable-based video compression structure in a video compression technology to support a hybrid task. In an adaptive loop filter step of an encoder of a layer for a machine task, a coding tree unit may be classified into a coding tree unit significant group and a coding tree unit insignificant group and for a coding tree unit significant group, a filter coefficient may be derived by using a feature domain minimum error method and a task error minimum error method.

An image signal encoding method according to the present disclosure may include an importance derivation step of deriving importance of pixels of coding tree units in a frame, a first classification step of obtaining a first group by performing first classification for coding tree units in the frame based on the derived importance, wherein the first group is a coding tree unit significant group or a coding tree unit insignificant group, a second classification step of obtaining a second group by performing second classification for coding tree units of the first group based on a direction or strength of an edge of coding tree units of the first group, a sub-block classification step of obtaining a third group by classifying coding tree units of the second group in a unit of a sub-block; wherein, the unit of the sub-block is a unit obtained by partitioning coding tree units in the frame, a step of performing filtering by deriving a filter for a sub-block of the third group, and a step of deriving a filter set group of the first group based on the derived filter and encoding a filter set group index representing the filter set group.

An image signal decoding method according to the present disclosure includes decoding a filter set group index of a first group from a bitstream to derive a filter set group of the first group, and performing filtering by deriving a filter for sub-blocks of a third group based on a filter set group of the first group, and the first group may be obtained by performing first classification for coding tree units in the frame based on importance of pixels of coding tree units in a frame, the first group may be a coding tree unit significant group or a coding tree unit insignificant group, the third group may be obtained by classifying coding tree units of a second group in a unit of a sub-block, the second group may be obtained by performing second classification for coding tree units of the first group based on a direction or strength of an edge of coding tree units of the first group and the unit of the sub-block may be a unit obtained by partitioning a coding tree unit in the frame.

In an image signal encoding/decoding method according to the present disclosure, the importance may be a value representing in a unit of a pixel a degree which is referred to importantly to derive a result when performing neural network-based object detection, object segmentation or object tracking for the frame.

In an image signal encoding/decoding method according to the present disclosure, the first classification may classify a coding tree unit in the frame into the coding tree unit significant group when an average value of the importance of pixels in a coding tree unit in the frame is equal to or greater than a certain value, and may classify a coding tree unit in the frame into the coding tree unit insignificant group when an average value of the importance of pixels in a coding tree unit in the frame is less than the certain value.

In an image signal encoding/decoding method according to the present disclosure, a flag representing whether a coding tree unit in the frame is the coding tree unit significant group or the coding tree unit insignificant group may be encoded in a unit of a coding tree unit in the frame.

In an image signal encoding/decoding method according to the present disclosure, a step of performing filtering by deriving the filter may be performed preferentially for the coding tree unit insignificant group between the coding tree unit significant group and the coding tree unit insignificant group.

In an image signal encoding/decoding method according to the present disclosure, derivation of the filter may be performed by a feature domain minimum error method, and the filter may be characterized by having the smallest average error in a pixel value between a feature map of a filtered sub-block obtained through a convolution layer by filtering a sub-block of the third group with the filter and a feature map of an original sub-block obtained through a convolution layer in a sub-block of the third group compared to other filters.

In an image signal encoding/decoding method according to the present disclosure, derivation of the filter may be performed by a task error minimum error method, and a coefficient of the filter may perform a neural network for a frame which performs filtering by designating an initial value of the filter in a unit of the third group and may be updated by using a backpropagation method to ensure high performance of a performance result of the neural network.

In an image signal encoding/decoding method according to the present disclosure, a filter set group of the first group may be derived separately for the coding tree unit significant group and the coding tree unit insignificant group.

In an image signal encoding/decoding method according to the present disclosure, the filter set group index is a unit of a slice in the frame, and may be used to encode information including filter set group indexes representing filter set groups of the first group included in the slice.

In an image signal encoding/decoding method according to the present disclosure, the maximum number of the filter set group indexes included in information encoded in the unit of the slice may be 4.

### Technical Effects

Encoding efficiency may be improved by deriving an adaptive filter coefficient for a coding tree group.

### DESCRIPTION OF DIAGRAMS

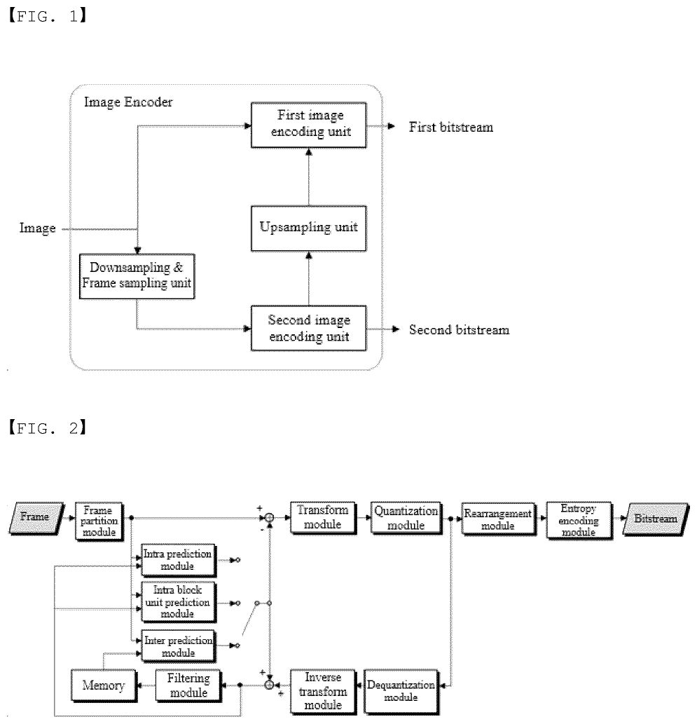

FIG. 1 is a block diagram of an image information encoder according to an embodiment of the present disclosure.

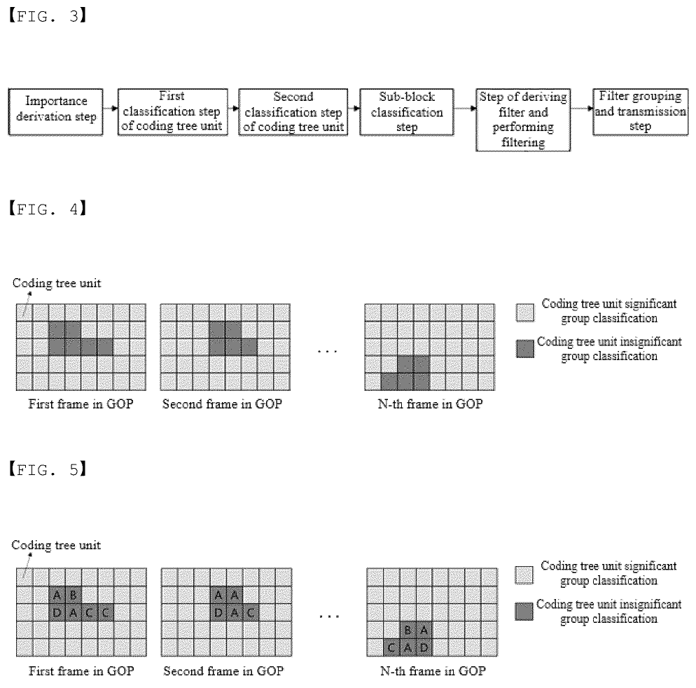

FIG. 2 is a diagram showing a prediction and transform based encoding structure in a second image encoding unit of FIG. 1 according to an embodiment of the present disclosure.

FIG. 3 a flowchart of a process of performing adaptive loop filtering according to an embodiment of the present disclosure.

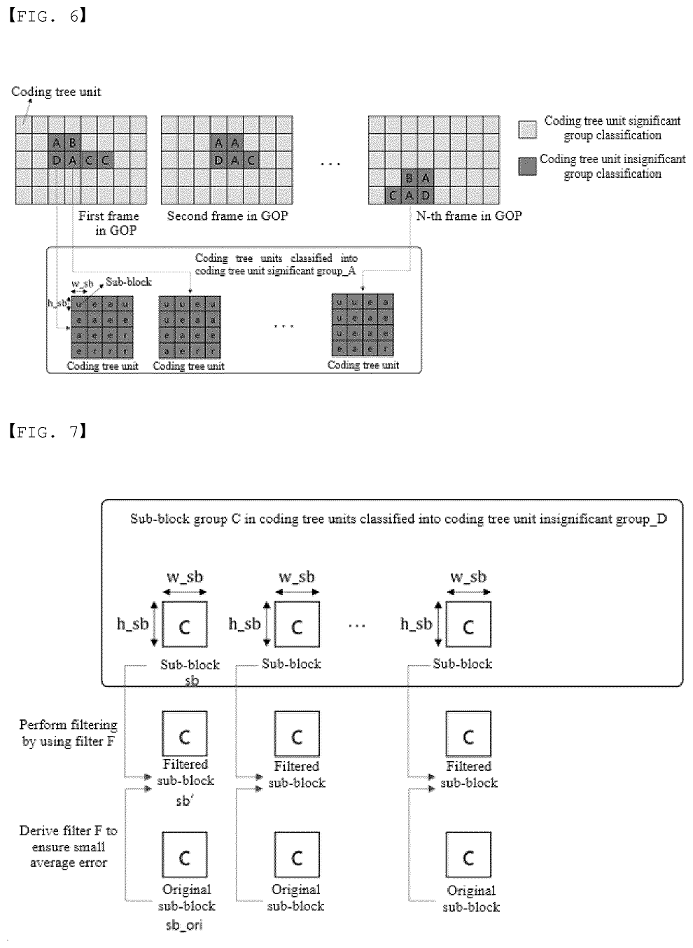

FIG. 4 is a diagram showing g an example of a first classification result of a coding tree unit according to an embodiment of the present disclosure.

FIG. 5 is a diagram showing a second classification result of a coding tree unit for a coding tree unit significant group according to an embodiment of the present disclosure.

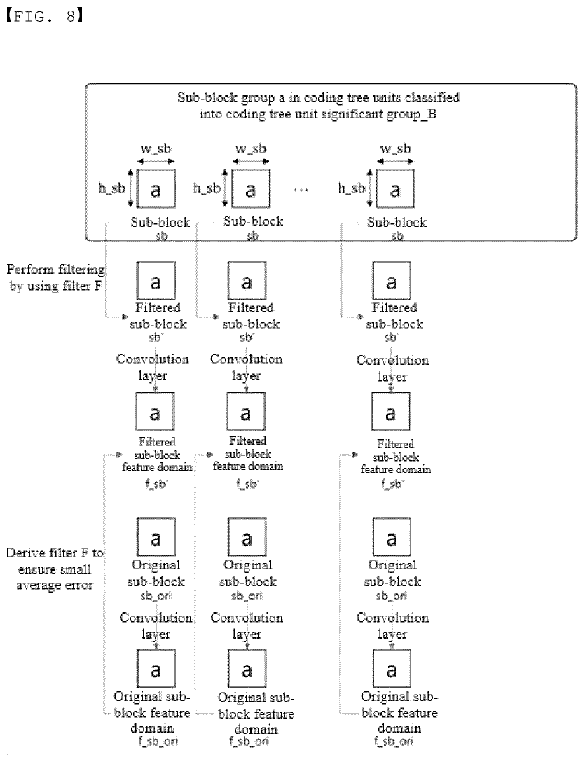

FIG. 6 is a diagram showing a sub-block classification result for a coding tree unit classified into coding tree unit significant group_A according to an embodiment of the present disclosure.

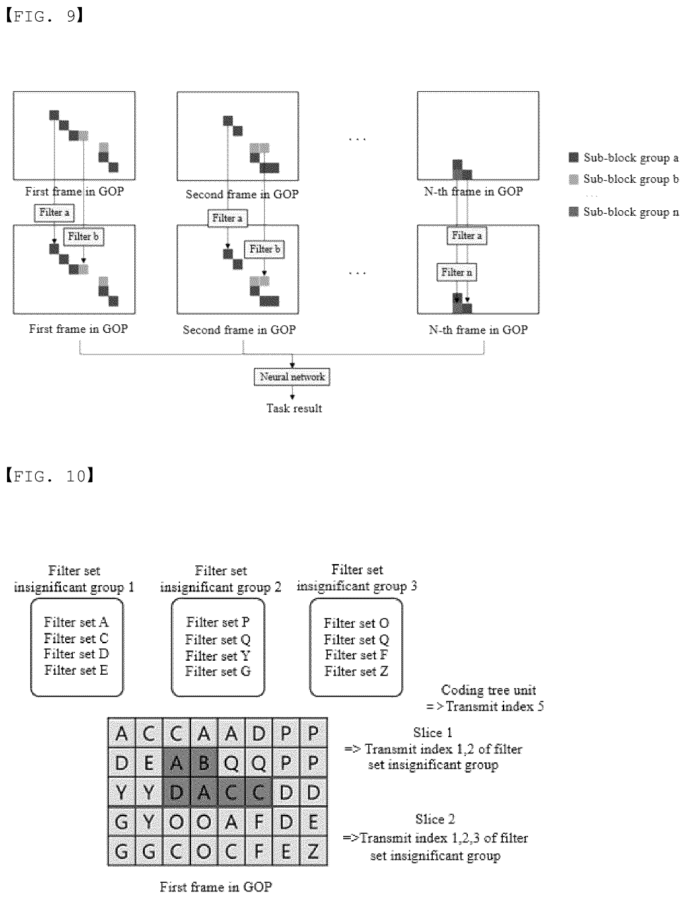

FIG. 7 is a diagram showing a process of deriving a filter for sub-block group c in coding tree units classified into coding tree unit insignificant group_D according to an embodiment of the present disclosure.

FIG. 8 is a diagram showing a process of deriving a filter for sub-block group a in coding tree units classified into coding tree unit significant group_B according to an embodiment of the present disclosure.

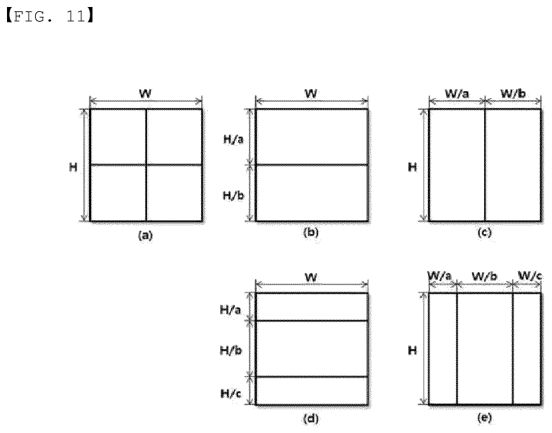

FIG. 9 is a diagram showing a process of deriving a filter by using a task error minimum error method for a sub-block group included in a coding tree unit significant group according to an embodiment of the present disclosure.

FIG. 10 is a diagram showing an example of a filter set group configuration according to an embodiment of the present disclosure.

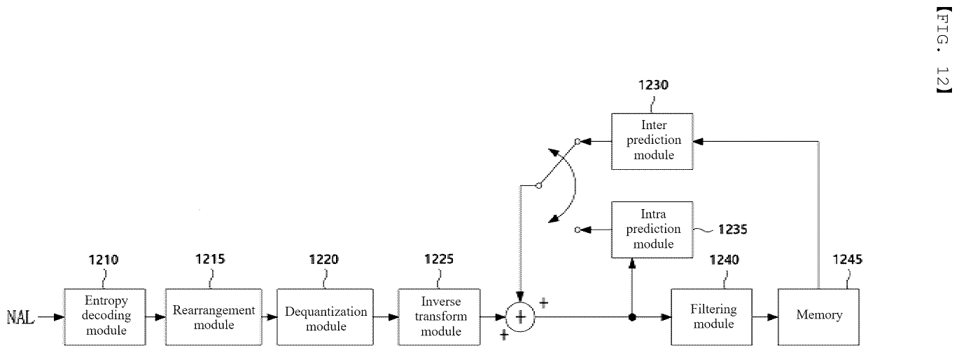

FIG. 11 is a diagram showing a partition type of a coding tree unit according to an embodiment of the present disclosure.

FIG. 12 is a diagram showing a rough block diagram of a decoding device according to an embodiment of the present disclosure.

### BEST MODE

A method for encoding an image according to the present disclosure, the method may comprise an importance derivation step of deriving importance of pixels of coding tree units in a frame, a first classification step of obtaining a first group by performing first classification for the coding tree units in the frame based on the derived importance; the first group being a coding tree unit significant group or a coding tree unit insignificant group, a second classification step of obtaining a second group by performing second classification for coding tree units of the first group based on a direction or strength of an edge of the coding tree units of the first group, a sub-block classification step of obtaining a third group by classifying coding tree units of the second group in a unit of a sub-block; the unit of the sub-block being the unit obtained by partitioning the coding tree units in the frame, a filtering step of performing filtering by deriving a filter for a sub-block of the third group; and an encoding step of deriving a filter set group of the first group based on the derived filter and encoding a filter set group index representing the filter set group.

### Mode

As the present disclosure may make various changes and have several embodiments, specific embodiments will be illustrated in a drawing and described in detail. But, it is not intended to limit the present disclosure to a specific embodiment, and it should be understood that it includes all changes, equivalents or substitutes included in an idea and a technical scope for the present disclosure. A similar reference sign is used for a similar component while describing each drawing.

A term such as first, second, A, B, etc. may be used to describe various components, but the components should not be limited by the terms. The terms are used only to distinguish one component from other components. For example, without going beyond a scope of a right of the present disclosure, a first component may be referred to as a second component and similarly, a second component may be also referred to as a first component. A term, and/or, includes a combination of a plurality of relative entered items or any item of a plurality of relative entered items.

When a component is referred to as being “linked” or “connected” to other component, it should be understood that it may be directly linked or connected to other component, but other component may exist in the middle. On the other hand, when a component is referred to as being “directly linked” or “directly connected” to other component, it should be understood that other component does not exist in the middle.

As a term used in this application is only used to describe a specific embodiment, it is not intended to limit the present disclosure. Expression of the singular includes expression of the plural unless it clearly has a different meaning contextually. In this application, it should be understood that a term such as “include” or “have”, etc. is to designate the existence of features, numbers, steps, motions, components, parts or their combinations entered in a specification, but is not to exclude the existence or possibility of addition of one or more other features, numbers, steps, motions, components, parts or their combinations in advance.

Unless otherwise defined, all terms used herein including technical or scientific terms have the same meaning as commonly understood by a person with ordinary skill in the art to which this invention pertains. Terms as defined in a commonly used dictionary should be interpreted as having the meaning consistent with the meaning in the context of the related technology, and unless explicitly defined in this application, they should not be interpreted in an ideal or excessively formal sense.

A video encoding apparatus and a video decoding apparatus which will be described below may be a server terminal such as a personal computer (PC), a laptop computer, a personal digital assistant (PDA), a portable multimedia player (PMP), a PlayStation portable (PSP), a wireless communication terminal, a smart phone, a TV application server, a service server, etc. or a user terminal such as various kinds of devices, etc., and may mean a variety of devices equipped with a communication device such as a communication modem, etc. for communicating with wired and wireless communication networks, a memory for storing various programs and data for inter or intra prediction to encode or decode an image, a microprocessor for executing a program to perform operation and control and others.

In addition, an image encoded in a bitstream by an image encoding device may be transmitted to an image decoding device through various communication interfaces such as a cable, a universal serial bus (USB), etc. or through a wired or wireless communication network, etc. such as Internet, a wireless local area network, a wireless LAN network, a wibro network, a mobile communication network, etc. in real or non-real time and may be decoded in an image decoding device, reconstructed into an image and regenerated.

Typically, a video may be configured with a series of pictures and each picture may be partitioned into predetermined regions such as a frame or a block.

In addition, a high efficiency video coding (HEVC) standard defines a concept of a coding unit (CU), a prediction unit (PU) and a transform unit (TU). An encoding unit is similar to an existing macroblock, but may perform encoding while variably adjusting a size of a coding unit. A prediction unit may be determined in a coding unit which is no longer partitioned and may be determined through a prediction type and a PU splitting process. As a transform unit is a transform unit for transform and quantization, it may be larger than a size of a prediction unit, but may not be larger than a coding unit. Accordingly, in the present disclosure, a block may be understood to have the same meaning as a unit.

In addition, a block or a pixel which is referred to for encoding or decoding a current block or a current pixel is referred to as a reference block or a reference pixel. In addition, a person with ordinary skill in the art to which this invention pertains may understand that a term “picture” described below may be used by being replaced with other terms with the equivalent meaning such as image, frame, etc.

Hereinafter, a desirable embodiment according to the present disclosure is described in detail with reference to an attached diagram.

FIG. 1 is a block diagram of an image encoder according to an embodiment of the present disclosure.

An image encoder of FIG. 1 may output at least one bitstream. An output bitstream may include at least one of a first bitstream generated from a first image encoding unit or a second bitstream generated from a second image encoding unit.

An image encoder of FIG. 1 may perform encoding in a second image encoding unit by downsampling an image or sampling a frame and upsample a reconstructed second image to perform encoding by using the upsampled reconstructed second image in a first image encoding unit. A first image encoding unit and a second image encoding unit may output a bitstream, respectively. An image encoder may be configured with at least one of a downsampling and frame sampling unit, a first image encoding unit, a second image encoding unit or an upsampling unit and each step may be omitted or order may be changed. A first image encoding unit and a second image encoding unit may have a prediction and transform based encoding structure, an entropy coding based encoding structure, a neural network based encoding structure, etc., respectively. A first image encoding unit may encode an image for a human vision and a second image encoding unit may encode an image for a machine vision. A first image encoding unit may have a different encoding structure (a prediction and transform based encoding structure, an entropy coding based encoding structure or a neural network based encoding structure) from a second image encoding unit. But, it is not limited thereto, and a first image encoding unit and a second image encoding unit may have the same structure. Index information for the encoding structure may be encoded and included in a bitstream.

A downsampling and frame sampling unit of FIG. 1 may downsample a resolution of an image input to an image encoder or sample a frame. When a resolution of an input image is lower than a pre-defined value, a downsampling or frame sampling process may be omitted. In this case, an upsampling process corresponding to the upsampling or the frame sampling process may be also omitted.

A second image encoding unit of FIG. 1 may encode a second image output from a downsampling and frame sampling unit of FIG. 1 and output a second bitstream. A second image encoding unit may have a prediction and transform based encoding structure, an entropy coding based encoding structure, a neural network based encoding structure, etc.

FIG. 2 is a diagram showing a prediction and transform based encoding structure in a second image encoding unit of FIG. 1 according to an embodiment of the present disclosure.

Each module shown in FIG. 2 is shown independently to represent different characteristic functions in a decoding device, which may mean that each module is configured with separate hardware. But, for convenience of a description, each module is listed and included as an individual module, and at least two modules of each module may be combined to configure one module or one module may be divided into a plurality of modules to perform a function, and an integrated embodiment and a separate embodiment of each of these modules are also included in a scope of a right of the present disclosure unless they do not deviate from the essence of the present disclosure.

A frame partition module of FIG. 2 may partition a frame into at least one of subframes, slices, tiles, coding tree units or coding units. A subframe may be a unit which may be independently encoded and transmitted like a frame and a boundary of a subframe may be encoded in the same way as a boundary of a frame. A slice may be independently encoded and may be a transmission unit due to the presence of a header. A tile may not have a header and may be a parallel encoding/decoding unit. A coding tree unit may be a non-overlapped unit in a N×N size, and starting from a coding tree unit, partition may be performed in a partition mode such as a quad tree (QT), a binary tree (BT), a ternary tree (TT), etc. to generate at least one coding unit. A coding unit may be a unit in which whether an intra prediction mode or an inter prediction mode is performed is determined, and prediction or transform may be performed with or without partition into sub-coding units. A sub-coding unit may be partitioned in the same partition mode as a partition mode of partition a coding tree unit.

FIG. 11 is a diagram showing a partition type of a coding tree unit according to an embodiment of the present disclosure.

FIG. 11 (a) shows quad tree partition (QT). A QT is a partition type which partitions a first coding unit into four second coding units. For example, when a coding tree unit of 2N×2N is partitioned into QTs, a coding tree unit may be partitioned into four coding units in a size of N×N. There may be a limit that a QT is applied only to a square coding unit, but it may be also applied to a non-square coding unit.

FIG. 11 (b) shows horizontal binary tree (hereinafter, referred to as horizontal BT) partition. A horizontal BT is a partition type that a first coding unit is partitioned into two second coding units by one horizontal line. The bipartition may be performed symmetrically or asymmetrically. For example, when a coding tree unit of 2N×2N is partitioned into horizontal BTs, a coding tree unit may be partitioned into two coding units with a height ratio of (a:b). Here, a and b may be the same value or a may be larger or smaller than b.

FIG. 11 (c) shows vertical binary tree (hereinafter, referred to as Vertical BT) partition. A vertical BT is a partition type that a first coding unit is partitioned into two second coding units by one vertical line. The bipartition may be performed symmetrically or asymmetrically. For example, when a coding tree unit of 2N×2N is partitioned into vertical BTs, a coding tree unit may be partitioned into two coding units with a width ratio of (a:b). Here, a and b may be the same value or a may be larger or smaller than b.

FIG. 11 (d) shows horizontal triple tree (hereinafter, referred to as Horizontal TT) partition. A horizontal TT is a partition type that a first coding unit is partitioned into three second coding units by two horizontal lines. For example, when a coding tree unit of 2N×2N is partitioned into horizontal TTs, a coding tree unit may be partitioned into three coding units with a height ratio of (a:b:c). Here, a, b and c may be the same value. Alternatively, a and c may be the same and b may be larger or smaller than a.

FIG. 11 (e) shows vertical triple tree (hereinafter, referred to as Vertical TT) partition. A vertical TT is a partition type that a first coding unit is partitioned into three second coding units by two vertical lines. For example, when a coding tree unit of 2N×2N is partitioned into vertical TTs, a coding tree unit may be partitioned into three coding units with a width ratio of (a:b:c). Here, a, b and c may be the same value or may be a different value. Alternatively, a and c may be the same and b may be larger or smaller than a. Alternatively, a and b may be the same and c may be larger or smaller than a. Alternatively, b and c may be the same and a may be larger or smaller than b.

An encoding device encodes partition information based on the above-described partition and transmits it through a bitstream and the partition information may be signaled in a decoding device and used for decoding. The partition information may include at least one of partition type information, partition direction information or partition ratio information.

The partition type information may specify any one of partition types which are pre-defined in an encoding/decoding device. The pre-defined partition type may include at least one of a QT, a horizontal BT, a vertical BT, a horizontal TT, a vertical TT or a no split mode. Alternatively, the partition type information may mean information on whether a QT, a BT or a TT is applied and it may be encoded in a form of a flag or an index. For a BT or a TT, the partition direction information may represent whether partition is performed in a horizontal direction or in a vertical direction. For a BT or a TT, the partition ratio information may represent a ratio of a width and/or a height of a second coding unit.

An intra prediction module of FIG. 2 may generate a prediction block of a coding unit by using a surrounding reconstructed reference sample of an input coding unit. Intra prediction may refer to a reconstructed sample on the left, right, top, or bottom of a current coding unit to generate a prediction block of a current coding unit by using a prediction mode such as a planar mode, a DC mode, a directional mode, a matrix product-based mode, a position-based weighted sum mode, etc. A reference sample to be used may be selected and filtering may be performed according to a prediction mode and it may be used to generate a prediction block. A sub-prediction unit of a reference sample may be generated by partitioning a coding unit horizontally or vertically. Encoding of a coding unit may be performed by sequentially encoding all or part of sub-prediction units in a coding unit in order from left to right or from top to bottom. A sub-prediction unit whose encoding order is not first may use a reconstructed value of a sub-prediction unit which is encoded right before as a reference sample.

When there are two or more sub-prediction units, encoding of a sub-prediction unit may be performed in encoding order between sub-prediction units. An encoding device may encode the encoding order or encoding information related to the encoding order and transmit it through a bitstream. In this case, encoding order between sub-prediction units of a decoding device may be signaled by a bitstream or may be determined by encoding information signaled from a bitstream. The encoding information may include a size/a shape of a coding unit, a partition type, the number of partitions, a component type, a prediction mode, a transform type, a transform skip mode, scan order, in-loop filter information, etc.

A surrounding reconstructed reference sample used for intra prediction may be a reference sample of all or part included in at least one of reference regions adjacent to the left, right, top, bottom, top-right or bottom-left of a current coding unit.

Information on a surrounding reconstructed reference sample or a reference region including a surrounding reconstructed reference sample may be encoded/decoded. The information may include information such as a position of a reference sample or a reference region, the number of reference samples used in the reference region, a size (width/height) of a reference region, a shape of a reference region, whether a reference sample or a reference region is available/unavailable, a prediction mode of a reference sample or a reference region, etc.

An intra block unit prediction module of FIG. 2 may be referred in a block unit in a surrounding reconstructed region of an input coding unit to generate a prediction block of a coding unit. A prediction block may be generated by searching a block having a value most similar to a current coding unit in a surrounding reconstructed region and a motion vector representing a position difference between a searched surrounding block and a prediction block may be transmitted. As a motion vector encoding method, a motion vector of a surrounding coding unit may be used as a prediction motion vector and an index of the surrounding coding unit may be transmitted.

An inter prediction module of FIG. 2 may generate a prediction block of a coding unit in a block unit by referring to an input coding unit and a different frame. Here, a different frame may represent a frame which is input/output, transmitted/received or encoded/decoded temporally before or after a current frame based on a current frame. In a unit of a coding unit or a sub-prediction unit, an optimal prediction block may be searched in a reference region of a different frame and a motion vector may be derived based on the searched optimal prediction block. As a motion vector encoding method, a motion vector of a surrounding coding unit may be used as a prediction motion vector and an index of the surrounding coding unit may be transmitted. A residual motion vector may be transmitted by subtraction from a prediction motion vector.

An index of the surrounding coding unit may indicate any one of candidate lists configured with surrounding coding units which may be used by a current coding unit or motion vectors of the surrounding coding units. The number of candidates of the candidate list is K and the K may be a natural number equal to or greater than 1. An encoding device may encode the number of candidates of the candidate list or information related to the number and transmit it through a bitstream. In this case, the number of candidates of the candidate list of a decoding device may be signaled by a bitstream or may be determined by encoding information signaled from a bitstream. The encoding information may include a size/a shape of a current coding unit, a partition type, the number of partitions, a component type, a prediction mode, a transform type, a transform skip mode, scan order, in-loop filter information, etc.

A transform module of FIG. 2 may derive a transform coefficient block by performing transform for a residual block obtained by subtracting a coding unit and a prediction block. A transform kernel may use DCT, DST, etc. The transform kernel may be determined based on at least one of a prediction mode (inter/intra prediction), a size/a shape of a block, an intra prediction mode, a component type (a luma/chroma component) or a partition type (a QT, a BT, a TT, etc.). When a coding unit performs intra prediction, transform may be performed for a transform unit in a size equal to or smaller than a unit which performs prediction. When a coding unit performs inter prediction, transform may be performed for a transform unit in a size equal to or smaller than a coding unit. In addition, second transform may be performed only for a partial region of a transform coefficient block. Information on whether the second transform is performed and a partial region where the second transform is performed may be encoded and transmitted through a bitstream.

A quantization module of FIG. 2 may derive a quantization level block by performing quantization for a transform coefficient block. A quantization parameter used to perform the quantization may be derived by adding a prediction quantization parameter and a residual quantization parameter. A prediction quantization parameter may be derived in a unit of a coding unit group and a residual quantization parameter may be derived in a unit of a coding unit. A quantization level block may be also derived by dividing a value of a transform coefficient block by a value corresponding to a quantization parameter.

A rearrangement module in FIG. 2 may partition a quantization level block in a k×l-sized non-overlapped rearrangement unit and scan it in order such as z scan order, raster scan order, etc. in a rearrangement unit to rearrange it in a line. Rearranged quantization levels may be input to an entropy encoding module of FIG. 2 through a binarization process.

An entropy encoding module of FIG. 2 may perform entropy encoding by receiving information to be transmitted generated in each module such as a quantization level of a transform block, partition information, prediction information, transform information, etc. A variety of encoding methods such as Exponential Golomb, Context-Adaptive Variable Length Coding (CAVLC) and Context-Adaptive Binary Arithmetic Coding (CABAC) may be used.

A filtering module of FIG. 2 may perform deblocking filtering, sample offset filtering, adaptive loop filtering, etc. for a reconstructed image. Deblocking filtering may perform lowpass filtering for a boundary of a n×m block. Sample offset filtering may add an offset in a unit of a pixel or add an offset to a pixel in a scope of specific value.

Adaptive loop filtering may perform filtering by deriving multiple filter sets in a unit of a frame group and selecting a filter in a unit of a sub-block in a size of w_sb×h_sb. A process of performing adaptive loop filtering may be the same as in FIG. 3. Information representing whether adaptive loop filtering is performed may be encoded/decoded.

FIG. 3 a flowchart of a process of performing adaptive loop filtering according to an embodiment of the present disclosure.

An importance derivation step of FIG. 3 may determine importance of each pixel in a frame for each frame in a frame group and designate a value in descending order based on importance. The importance may refer to a value representing in a unit of a pixel a degree which is referred to importantly to derive a result when performing neural network based object detection, object segmentation, object tracking, etc. for a frame. The importance may be derived by performing an importance derivation network for a frame.

First classification of a coding tree unit of FIG. 3 may classify a coding tree unit in a frame into a coding tree unit significant group and a coding tree unit insignificant group based on an importance derivation result of FIG. 3. When an average value of importance of pixels in a coding tree unit is equal to or greater than a certain value, it may be classified into a coding tree unit significant group and when an average value of importance of pixels in a coding tree unit is less than a certain value, it may be classified into a coding tree unit insignificant group. Whether it is an significant group or an insignificant group may be transmitted as a flag in a unit of a coding tree unit. Subsequently, a process of deriving a filter and performing a filter may be performed preferentially for a coding tree unit insignificant group and may be performed for a coding tree unit significant group. A result of first classification of a coding tree unit may be the same as in FIG. 4.

FIG. diagram showing an example of a first classification result of a coding tree unit according to an embodiment of the present disclosure.

Second classification of a coding tree unit of FIG. 3 may perform second classification for coding tree units in each group for each of a coding tree unit significant group and a coding tree unit insignificant group in the entire Group Of Pictures (GOP). It may be classified based on a direction of an edge, strength of an edge, etc. in a coding tree unit. A second classification result of a coding tree unit may be the same as in FIG. 5.

FIG. 5 is a diagram showing a second classification result of a coding tree unit for a coding tree unit significant group according to an embodiment of the present disclosure. A sub-block classification step of FIG. 3 may classify a sub-block into num_sb sub-blocks in a unit of a w_sb×h_sb sub-block for coding tree units classified into the same group in second classification of a coding tree unit of FIG. 5. A sub-block classification result for one coding tree unit significant group may be the same as in FIG. 6.

FIG. 6 is a diagram showing a sub-block classification result for a coding tree unit classified into coding tree unit significant group_A according to an embodiment of the present disclosure.

In a step of deriving a filter and performing filtering in FIG. 3, one filter may be derived for sub-blocks classified into one group in a sub-block classification step of FIG. 6 and filtering may be performed for a sub-block by using a derived filter. For a sub-block group included in a coding tree unit insignificant group, a filter may be derived by a minimum error method. A filter which minimizes an average error in a pixel value between a filtered sub-block and an original sub-block may be derived. A process of deriving a filter may be the same as FIG. 7.

FIG. 7 is a diagram showing a process of deriving a filter for sub-block group c in coding tree units classified into coding tree unit insignificant group_D according to an embodiment of the present disclosure.

For a sub-block group included in a coding tree unit significant group, a filter may be derived by a feature domain minimum error method. A filter which minimizes an average error in a pixel value between a feature map extracted through a convolution layer in a filtered sub-block and a feature map extracted through a convolution layer in an original sub-block may be derived. A process of deriving a filter may be the same as FIG. 8.

FIG. 8 is a diagram showing a process of deriving a filter for sub-block group a in coding tree units classified into coding tree unit significant group_B according to an embodiment of the present disclosure.

For a sub-block group included in a coding tree unit significant group, a filter may be derived by a task error minimum error method. An initial value of a filter may be designated for each sub-block group, a neural network may be performed for a frame in which filtering is performed and a coefficient of a filter may be updated by using a backpropagation method to ensure high performance of a performance result. A process of deriving a filter may be the same as in FIG. 9.

FIG. 9 is a diagram showing a process of deriving a filter by using a task error minimum error method for a sub-block group included in a coding tree unit significant group according to an embodiment of the present disclosure.

In a filter grouping and transmission step of FIG. 3, filter sets derived in a unit of a coding tree unit group may be grouped and transmitted in a filter set group. Filter sets for a coding tree unit significant group and a coding tree unit insignificant group may be grouped separately and transmitted in a filter set significant group and a filter set insignificant group.

Filter sets of a coding tree unit group which exists in a slice may be included in a filter set group in a unit of a slice and when the maximum number of filter sets is included, the remaining filter sets may be included in a next filter set group. A filter set may be included in a filter set group without duplication.

Up to num_filterset_group indexes of a filter set group that filter sets of a coding tree unit group which exists in a slice are included may be transmitted in a unit of a slice and a filter set index may be transmitted in a unit of a coding tree unit.

An example of a filter set group may be the same as in FIG. 10.

FIG. 10 is a diagram showing an example of a filter set group configuration according to an embodiment of the present disclosure.

FIG. 12 is a diagram showing a rough block diagram of a decoding device according to an embodiment of the present disclosure.

In reference to FIG. 12, a decoding device 1200 may include an entropy decoding module 1210, a rearrangement module 1215, a dequantization module 1220, an inverse transform module 1225, a prediction module 1230 and 1235, a filtering module 1240 and a memory 1245. A decoding device may further include a frame partition module and the frame partition module may be included in each module or may be separately separated.

Each module of a decoding device may perform a function corresponding to modules of an encoding device. Accordingly, some of detailed contents described above in an encoding device are omitted below.

Each module shown in FIG. 12 is shown independently to represent different characteristic functions in a decoding device, which may mean that each module is configured with separate hardware. But, for convenience of a description, each module is listed and included as an individual module, and at least two modules of each module may be combined to configure one module or one module may be divided into a plurality of modules to perform a function, and an integrated embodiment and a separate embodiment of each of these modules are also included in a scope of a right of the present disclosure unless they do not deviate from the essence of the present disclosure.

An entropy decoding module 1210 may perform entropy decoding for an input bitstream. For example, for entropy decoding, a variety of methods such as Exponential Golomb, CAVLC (Context-Adaptive Variable Length Coding) and CABAC (Context-Adaptive Binary Arithmetic Coding) may be applied. An entropy decoding module 1210 may decode information related to intra prediction and inter prediction performed in a encoding device.

A rearrangement module 1215 may perform rearrangement for a bitstream which is entropy-decoded in an entropy decoding module 1210. Quantization levels expressed in a form of a one-dimensional vector may be reconstructed and rearranged into a k×l quantization level block in a form of a two-dimensional block according to scan order. A rearrangement module 1215 may receive information related to coefficient scanning performed in an encoding device and perform rearrangement through a reverse scanning method based on scanning order performed in a corresponding encoding device.

A dequantization module 1220 may perform dequantization for a quantization level block to derive a transform coefficient block. A dequantization parameter used to perform the dequantization may be derived by combining a prediction dequantization parameter and a residual dequantization parameter. A prediction dequantization parameter may be derived in a unit of a coding unit group and a residual dequantization parameter may be derived in a unit of a coding unit.

An inverse transform module 1225 may inversely transform a dequantized transform coefficient block in a predetermined transform type. In this case, a transform kernel may use DCT, DST, etc. The transform kernel may be determined based on at least one of a prediction mode (inter/intra prediction), a size/a shape of a block, an intra prediction mode, a component type (a luma/chroma component) or a partition type (a QT, a BT, a TT, etc.). When a coding unit performs intra prediction, inverse transform may be performed for a transform unit in a size equal to or smaller than a unit that prediction is performed. When a coding unit performs inter prediction, inverse transform may be performed for a transform unit in a size equal to or smaller than a coding unit. In addition, second inverse transform may be performed only for some regions of a transform coefficient block. Information on whether the second inverse transform is performed and some regions where the second inverse transform is performed may be signaled from a bitstream.

A frame partition module may partition a frame into at least one of a subframe, a slice, a tile, a coding tree unit or a coding unit. A subframe may be a unit which may be independently decoded like a frame and a boundary of a subframe may be decoded in the same way as a boundary of a frame. A slice may be decoded independently and may be a transmission unit due to the presence of a header. A tile may not have a header and may be a parallel encoding/decoding unit. Details regarding partition of a coding tree unit are described above in an encoding device, so they are omitted below.

A prediction module 1230 and 1235 may generate a prediction block of a coding unit based on prediction block generation-related information provided in an entropy decoding module 1210 and previously decoded block or frame information provided in a memory 1245.

An intra prediction module 1235 of FIG. 12 may generate a prediction block of a coding unit by using a surrounding reconstructed reference sample of an input coding unit. Intra prediction may refer to a reconstructed sample on the left, right, top or bottom of a current coding unit to generate a prediction block of a current coding unit by using a prediction mode such as a planar mode, a DC mode, a directional mode, a matrix product-based mode, a position-based weighted sum mode, etc. A reference sample to be used may be selected and filtering may be performed according to a prediction mode and it may be used to generate a prediction block. A sub-prediction unit of a reference sample may be generated by partitioning a coding unit horizontally or vertically. Decoding of a coding unit may be performed by sequentially decoding all or part of sub-prediction units in a coding unit in order from left to right or from top to bottom. A sub-prediction unit whose decoding order is not first may use a reconstructed value of a sub-prediction unit which is decoded immediately before as a reference sample.

When there are two or more sub-prediction units, decoding of a sub-prediction unit may be performed in decoding order between sub-prediction units. A decoding device may signal the decoding order or decoding information related to the decoding order from a bitstream. When decoding information related to decoding order is signaled, the decoding order may be determined by decoding information related to the decoding order. Decoding information related to the decoding order may include a size/a shape of a coding unit, a partition type, the number of partitions, a component type, a prediction mode, a transform type, a transform skip mode, scan order, in-loop filter information, etc.

Details regarding a surrounding reconstructed reference sample used for intra prediction are described above in an encoding device, so they are omitted below.

An intra block unit prediction module of FIG. 12 may be referred in a unit of a block in a surrounding reconstructed region of an input coding unit to generate a prediction block of a coding unit. A prediction block may be generated by searching a block having a value most similar to a current coding unit in a surrounding reconstructed region and a motion vector representing a position difference between a searched surrounding block and a prediction block may be transmitted. As a motion vector decoding method, an index of a surrounding coding unit may be signaled from a bitstream to use a motion vector of the surrounding coding unit as a prediction motion vector.

An inter prediction module of FIG. 12 may generate a prediction block of a coding unit in a unit of a block by referring to a current coding unit and a different frame. Here, a different frame may which is represent a frame input/output, transmitted/received or encoded/decoded temporally before or after a current frame based on a current frame. In a unit of a coding unit or a sub-prediction unit, an optimal prediction block may be searched in a reference region of a different frame and a motion vector may be derived based on the searched optimal prediction block. As a motion vector decoding method, an index of a surrounding coding unit may be signaled from a bitstream to use a motion vector of the surrounding coding unit as a prediction motion vector. A motion vector may be obtained by adding a prediction motion vector to a residual motion vector signaled from a bitstream. A description for an index of the surrounding coding unit is described above in an coding device, so it is omitted below.

A filtering module 1240 may perform deblocking filtering, sample offset filtering, adaptive loop filtering, etc. for a reconstructed image. Contents of each filtering are described above in an encoding device, so they are omitted below.

A memory 1245 may store a reconstructed frame or block to use it as a reference frame or a reference block and may also provide a reconstructed frame to an output unit.

An image decoding method according to the present disclosure may include decoding a filter set group index of a first group from a bitstream to derive a filter set group of the first group and performing filtering by deriving a filter for sub-blocks of a third group based on a filter set group of the first group. Here, the first group is obtained by performing first classification for coding tree units in the frame based on importance of each pixel in a frame and the first group may be a coding tree unit significant group or a coding tree unit insignificant group. In addition, coding tree units of the first group may be subject to second classification based on a direction or strength of an edge of coding tree units of the first group to obtain a second group. In addition, the third group may be obtained by classifying coding tree units of the second group in a unit of a sub-block. In addition, a unit of the sub-block may be a unit obtained by partitioning a coding tree unit in the frame.

Exemplary methods of the present disclosure are expressed as a series of operations for clarity of a description, but it is not intended to limit order in which steps are performed and if necessary, each step may be performed simultaneously or in different order. In order to implement a method according to the present disclosure, other step may be additionally included in an exemplary step or some steps may be excluded and the remaining steps may be included or some steps may be excluded and an additional other step may be included.

A variety of embodiments of the present disclosure do not enumerate all possible combinations, but are intended to describe a representative aspect of the present disclosure, and matters described in a variety of embodiments may be applied independently or in combination of two or more.

In addition, a variety of embodiments of the present disclosure may be implemented by hardware, firmware, software or a combination thereof. For implementation by hardware, implementation may be performed by one or more ASICs (Application Specific Integrated Circuits), DSPs (Digital Signal Processors), DSPDs (Digital Signal Processing Devices), PLDs (Programmable Logic Devices), FPGAS (Field Programmable Gate Arrays), general processors, controllers, microcontrollers, microprocessors, etc.

A scope of the present disclosure includes software or machine-executable instructions which execute an operation according to a method of a variety of embodiments on a device or a computer (e.g., an operating system, an application, a firmware, a program, etc.), and a non-transitory computer-readable medium that such software or instruction, etc. is stored and executable on a device or a computer.

1. A method for encoding an image, the method comprising:
an importance derivation step of deriving importance of pixels of coding tree units in a frame;
a first classification step of obtaining a first group by performing first classification for the coding tree units in the frame based on the derived importance; the first group being a coding tree unit significant group or a coding tree unit insignificant group,
a second classification step of obtaining a second group by performing second classification for coding tree units of the first group based on a direction or strength of an edge of the coding tree units of the first group;
a sub-block classification step of obtaining a third group by classifying coding tree units of the second group in a unit of a sub-block; the unit of the sub-block being the unit obtained by partitioning the coding tree units in the frame,
a filtering step of performing filtering by deriving a filter for a sub-block of the third group; and
an encoding step of deriving a filter set group of the first group based on the derived filter and encoding a filter set group index representing the filter set group.

2. The method of claim 1,
wherein the importance is a value representing in a unit of a pixel a degree which is referred to importantly to derive a result when performing neural network-based object detection, object segmentation or object tracking for the frame.

3. The method of claim 2,
wherein the first classification classifies a coding tree unit in the frame into the coding tree unit significant group when an average value of the importance of pixels in the coding tree unit in the frame is equal to or greater than a certain value, and
wherein the first classification classifies the coding tree unit in the frame into the coding tree unit insignificant group when the average value of the importance of pixels in the coding tree unit in the frame is less than the certain value.

4. The method of claim 3,
wherein a flag representing whether the coding tree unit in the frame is the coding tree unit significant group or the coding tree unit insignificant group is encoded in a unit of the coding tree unit in the frame.

5. The method of claim 4,
wherein the filtering step of performing filtering by deriving the filter is performed preferentially for the coding tree unit insignificant group between the coding tree unit significant group and the coding tree unit insignificant group.

6. The method of claim 5,
wherein derivation of the filter is performed by a feature domain minimum error method, and
wherein the filter is characterized by having a smallest average pixel value error between a feature map of the filtered sub-block obtained through a convolution layer by filtering the sub-block of the third group with the filter and a feature map of an original sub-block obtained through the convolution layer in the sub-block of the third group compared to other filters.

7. The method of claim 5,
wherein derivation of the filter is performed by a task error minimum error method,
wherein a coefficient of the filter is updated by using a backpropagation method that improves a performance result of a neural network, and
wherein the neural network is performed on a frame on which filtering has been performed by specifying an initial value of the filter in a unit of the third group.

8. The method of claim 1,
wherein the filter set group of the first group is derived separately for the coding tree unit significant group and the coding tree unit insignificant group.

9. The method of claim 8,
wherein the filter set group index is used to encode information including filter set group indexes representing filter set groups of the first group included in a slice in the frame in a unit of the slice.

10. The method of claim 9,
wherein a maximum number of the filter set group indexes included in the information encoded in the unit of the slice is 4.

11. A method for decoding an image, the method comprising:
deriving a filter set group of a first group by decoding a filter set group index of the first group from a bitstream;
performing filtering by deriving a filter for sub-blocks of a third group based on the filter set group of the first group,
wherein the first group is obtained by performing first classification for coding tree units in a frame based on importance of pixels of the coding tree units in the frame,
wherein the first group is a coding tree unit significant group or a coding tree unit insignificant group,
wherein the third group is obtained by classifying coding tree units of a second group in a unit of a sub-block, and
wherein the second group is obtained by performing second classification for coding tree units of the first group based on a direction or strength of an edge of coding tree units of the first group,
wherein the unit of the sub-block is the unit obtained by partitioning the coding tree units in a frame.

12. A computer readable recording medium storing a bitstream generated by an image encoding method, wherein:
the image encoding method includes:
an importance derivation step of deriving importance of pixels of coding tree units in a frame;
a first classification step of obtaining a first group by performing first classification for the coding tree units in the frame based on the derived importance; the first group being a coding tree unit significant group or a coding tree unit insignificant group;
a second classification step of obtaining a second group by performing second classification for coding tree units of the first group based on a direction or strength of an edge of the coding tree units of the first group;
a sub-block classification step of obtaining a third group by classifying coding tree units of the second group in a unit of a sub-block; the unit of the sub-block being the unit obtained by partitioning the coding tree units in the frame;
a filtering step of performing filtering by deriving a filter for a sub-block of the third group; and
an encoding step of deriving a filter set group of the first group based on the derived filter and encoding a filter set group index representing the filter set group.
